(19) United States
(12) Patent Application Publication
(10) Pub. No.: US 2002/0152957 A1
(43) Pub. Date: Oct. 24, 2002

(54) Device for two-dimensional application of free-flowing adhesive to strip material, especially furniture edge banding, in motion relative to the device

(75) Inventor: Colin Pedigrew, Erkrath (DE)

Correspondence Address: KEVIN G. ROONEY, WOOD, HERRON & EVANS, L.L.P., 2700 CAREW TOWER, CINCINNATI, OH, 45202, US

(73) Assignee: Nordson Corporation, Westlake, OH

(21) Appl. No.: 09/972,089

(22) Filed: Oct. 5, 2001

(30) Foreign Application Priority Data
Oct. 16, 2000 (DE) 10051201.1

(51) Int. Cl. B05C 3/02

(52) U.S. Cl. 118/410

(57) ABSTRACT

The invention pertains to a device for the two-dimensional application of free-flowing adhesive to strip material, especially to furniture edge banding, which material is in motion relative to the device, with an adhesive channel in the applicator head (2), with an applicator valve for the selective blocking or release of the flow of adhesive in the adhesive channel, and with a slot nozzle (16) communicating with the adhesive channel, which nozzle has a slot and an elongated, slot-shaped exit opening (18) for dispensing adhesive onto the strip material. It is proposed according to the invention that a guide device (3) for guiding the strip material past the exit opening (18) of the slot nozzle (16) along a defined path be attached removably to the applicator head (2), that the guide device (3) have a first guide element (38), which comes in contact during operation with the surface of the strip material opposite the surface to be glued, and at least one additional guide element (46, 48), which comes in contact during operation with an edge of the strip material.

The present invention pertains to a device for the two-dimensional application of free-flowing adhesive to a strip material, especially furniture edge banding, which is in motion relative to the device, with an adhesive channel in an applicator head, with an applicator valve for the selective blocking or release of the flow of adhesive in the adhesive channel, and with a slot nozzle communicating with the adhesive channel, which nozzle comprises a slot and an elongated, slot-shaped exit opening for discharging the adhesive onto the strip material.

Devices of this type are used to apply adhesives two-dimensionally to furniture parts or strip-like substrates. The applicator head is usually mounted on a frame, and the strip material is conducted past the applicator head by a transport device. During operation, the adhesive emerges from the elongated exit opening of the slot of the slot nozzle assembly and is dispensed onto the surface of the substrate being conducted past the exit opening. The elongated exit opening of the slot is usually oriented crosswise to the direction of the relative motion between the applicator head and the substrate.

When so-called edge banding is glued to the edges of furniture, the procedure used so far according to the state of the art is to apply glue to the edge of a furniture part and then to press the edge banding, which is a flexible material strip of plastic, onto the previously glued edge of the furniture part, so that an adhesive bond is formed between the two. The glue is applied to the furniture part either by hand with considerable effort or with the help of automatic devices, which apply the adhesive by machine to the furniture parts. In both cases, considerable expense is involved.

The task of the present invention is to provide an application device and a guide device which are suitable for applying an adhesive directly to strip material or the like. In particular, an application device is to be provided by means of which edge banding, molding, or the like can be easily and precisely applied to furniture parts or other workpieces.

The invention accomplishes this task with an applicator device of the general type described above by attaching the guide device, which guides the strip material past the exit opening of the slot nozzle along a defined path, removably to the applicator head, and by providing the guide device with a first guide element, which comes in contact during operation with the surface of the strip material opposite the surface to be glued, and with at least one additional guide element, which comes in contact during operation with an edge of the strip material.

The invention also accomplishes its task by a guide device for conducting strip material past an exit opening of a slot nozzle along a defined path, where the guide device has a first guide element, which comes in contact during operation with the surface of the strip material opposite the surface to be glued, and at least one additional guide element, which comes in contact during operation with an edge of the strip material.

With a simple design, the invention makes it possible to apply adhesive precisely and reliably in two dimensions to strip material, edge banding for furniture parts, molding strips, etc. The guide device according to the invention has a first guide element which ensures that the strip material to be glued is conducted past the exit opening of the slot nozzle either at an adjustable distance or in actual contact with the slot nozzle, so that the free-flowing adhesive is applied reliably and uniformly to the surface of the strip material to be glued. According to the invention, furthermore, the gluing as such and its quality can be influenced by adjusting the distance between the guide element and the exit opening, as a result of which the thickness of the applied glue can be controlled. By means of at least one additional (edge) guide element, the strip material to be glued is also guided laterally along the desired path, so that the optimum orientation of the strip material to be glued relative to the exit opening of the slot nozzle is achieved. Through the attachment of the guide device directly to the applicator head, complicated support structures can be eliminated, and the guide device can be easily retrofitted to existing applicator heads. If an applicator head is also used for a different purpose which does not require the guidance of a strip-like substrate, the guide device can be easily removed from the applicator head. After the application of the adhesive according to the invention to the strip material, the material can be bonded to other work-pieces; for example, edge banding can be glued to furniture parts.

In a preferred embodiment of the invention, it is proposed that the guide device is supported by means of a swivel joint on the applicator head so that it can swivel. As a result of this swiveling support, the guide device can move easily by virtue of its design so that, first, it can be adjusted to accommodate strip material of different thicknesses and, second, so that the first guide element can be moved between a contact position, in which the strip material to be glued is pressed against the nozzle assembly to create contact with the surface to be glued, and a rest position, in which, in the case that production is interrupted or no gluing is to be performed, the guide element makes no contact with either the slot nozzle or with the strip material.

According to a further elaboration of this embodiment, it is proposed that the guide device be swiveled by means of a pneumatic cylinder, and that the first guide element be mounted at such as a distance from the swivel joint that, when the guide device is swiveled, the distance between the first guide element and the exit opening of the slot nozzle changes. In this way, the movement between the working position and the rest position can be easily produced.

Another preferred embodiment is characterized by a preloading device to exert a preloading force on the guide device and/or the guide element toward a rest position, in which the guide element is held a certain distance away from the slot nozzle. The preloading device is preferably designed as a spring. As a result, the goal is achieved that, in the case of an unwanted interruption in the operation (emergency shutdown), the strip material to be glued will not be pressed against the slot nozzle, which may be heated; instead, the guide element will be swiveled into a rest position a certain distance away from the exit opening of the slot nozzle.

In a variant of the guide device according to the invention, it is provided that the first guide element is designed as a cylindrical bolt, which is set up essentially parallel to the exit opening. Such cylindrical bolts are easy to manufacture and provide reliable guidance with little friction. As an alternative, the first guide element could also be designed as a plate or as a rotating roll.

In another preferred embodiment, it is proposed that two additional edge-guide elements be attachable to a support at variable distances from each other. By means of these two edge-guide elements, the substrate to be glued is guided on both sides so that no unwanted shifting relative to the elongated exit opening of the slot can occur. Because the distances between the two elements is variable, it is also possible to adapt the guide to strip material of different widths.

It is also preferred that the support be mounted so that its position, along with that of the edge-guide elements, can be adjusted and then fixed in place on the guide device, so that the two edge-guide elements can also be aligned jointly, relative to the strip material. In another preferred embodiment, it is proposed that the guide device be provided with a guide slot formed by plates a certain distance apart, through which slot the material to be glued is conducted. With the help of this guide slot, it is possible to process in particular strip materials which have already been cut into sections. Such sections of material are fed reliably through the guide slot to the slot nozzle, even if the material is flexible or has the tendency to bunch up, as can be the case with edge banding.

Additional preferred embodiments are described in the subclaims and are explained in the following description of the figures.

The invention is described below on the basis of exemplary embodiments with reference to the attached drawings:

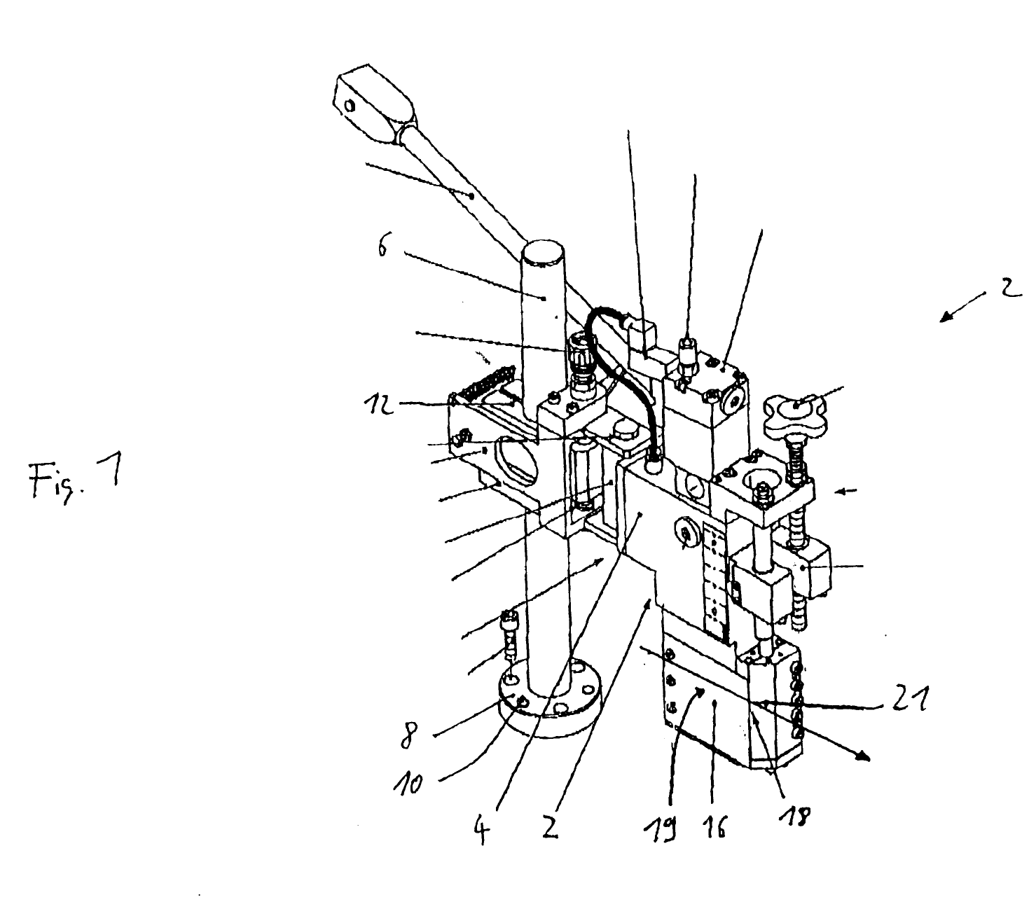

FIG. 1 is a perspective view of a device according to the invention for applying adhesive;

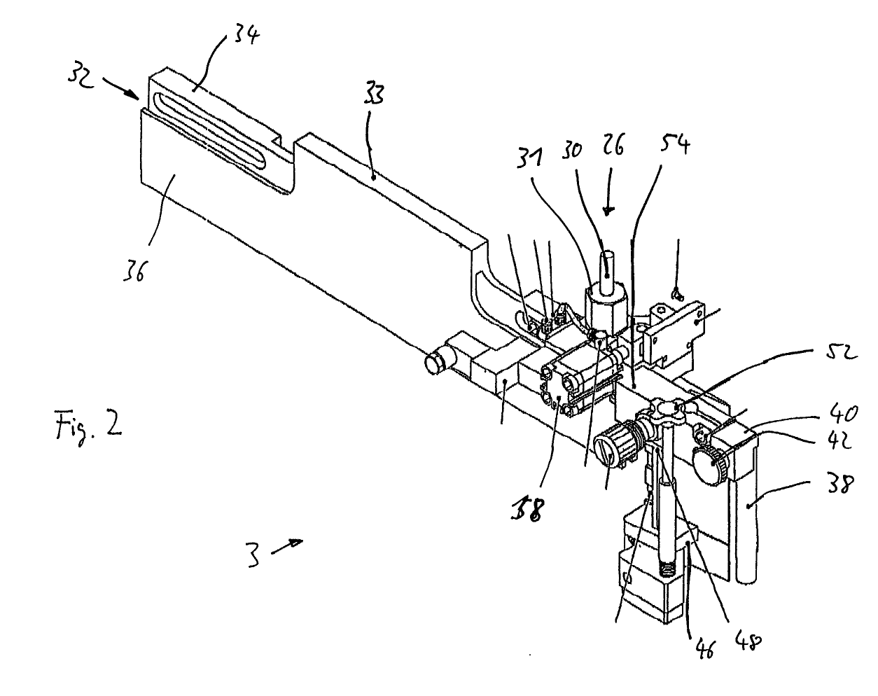

FIG. 2 is a perspective view of a guide device according to the invention;

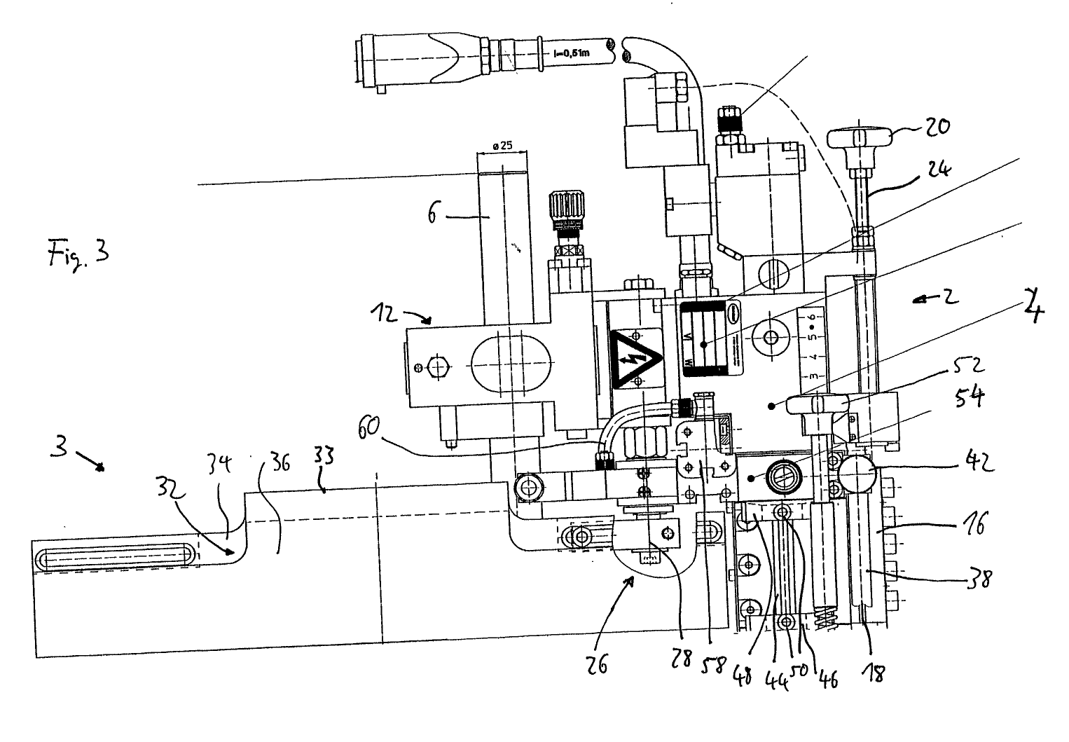

FIG. 3 is a side view of the applicator device according to FIG. 1 with a mounted guide device according to FIG. 2;

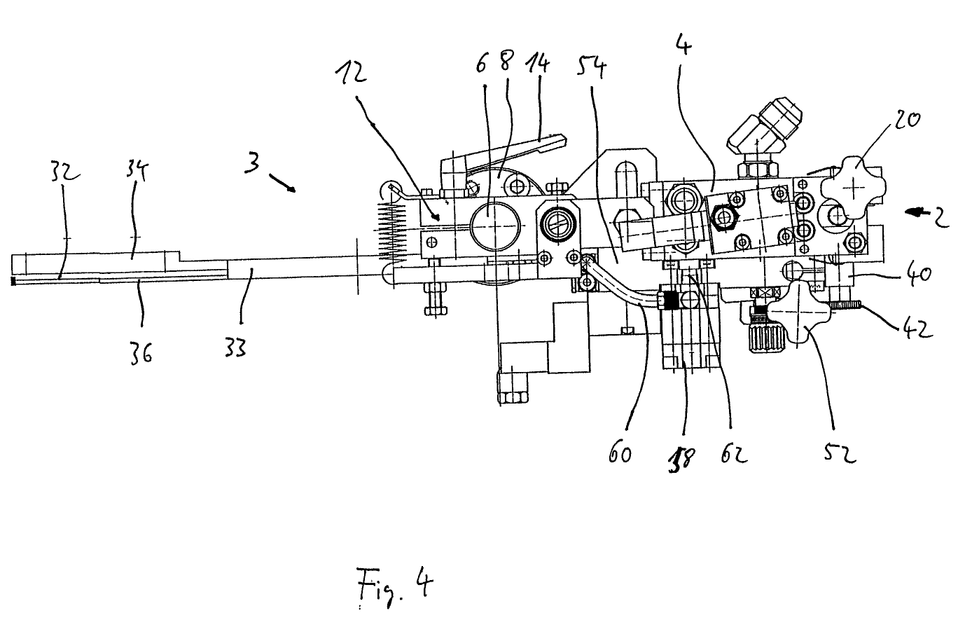

FIG. 4 is a plan view of the device according to FIG. 3;

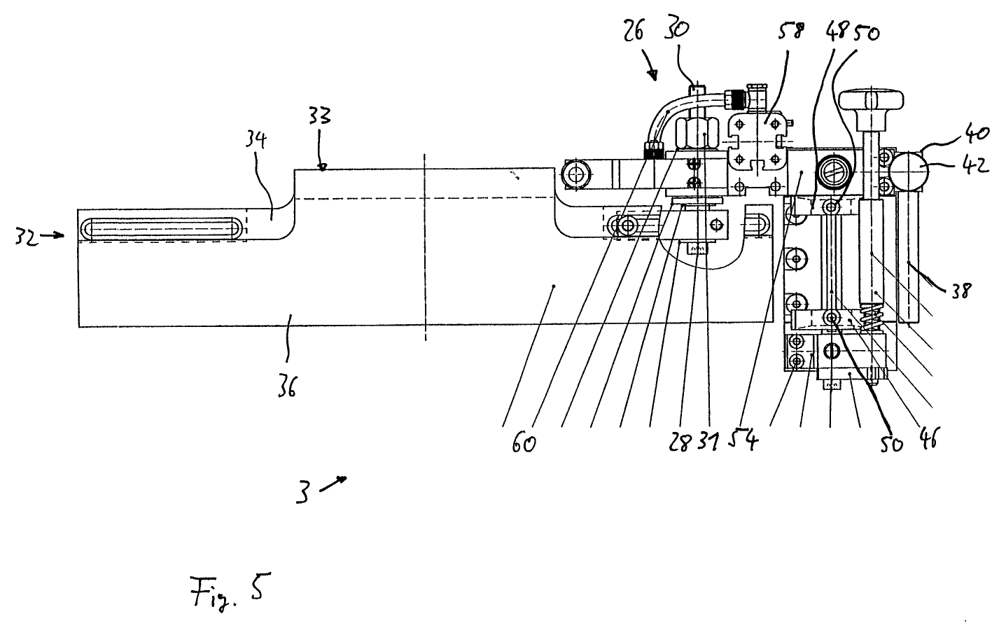

FIG. 5 is a side view of the guide device according to FIG. 2; and

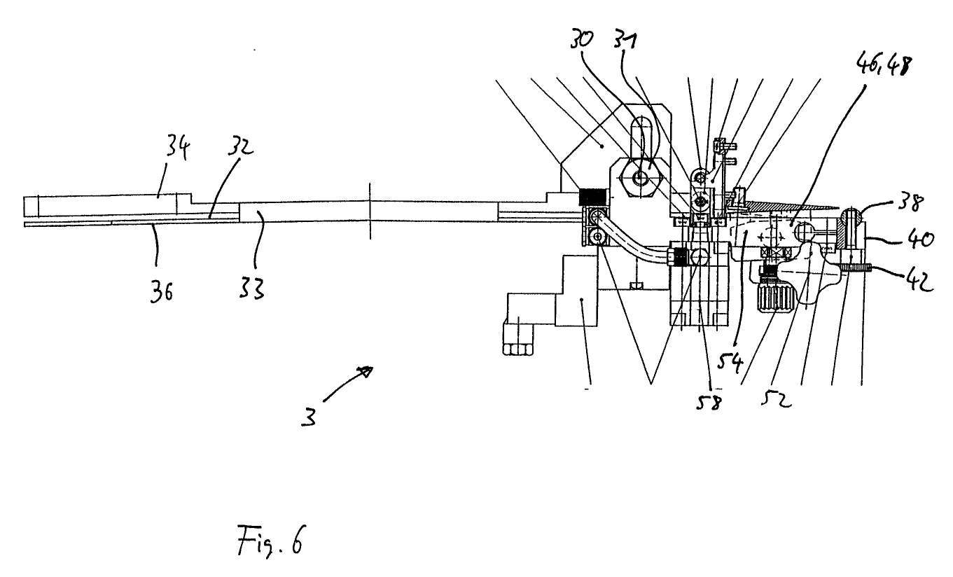

FIG. 6 is a plan view of the guide device according to FIG. 2.

The applicator device 2 and guide device 3 shown in the figures serve to apply adhesive to strip material, which can move relative to the applicator device 2; they are used especially for the gluing of so-called edge banding for furniture (furniture edge banding), which consists, for example, of flat, flexible plastic material, which is glued to the external surfaces of furniture or parts of furniture. Of course, other substrates such as molding, packaging material, etc., could also be coated with adhesive in two dimensions with the same devices.

As FIGS. 1 to 4 show with particular clarity, an applicator head 2 has a base body 4 with an adhesive channel (not shown) in this base body 4. A support post 6 is used to support and position the applicator head 2 permanently in a defined position. The support post 6 is provided at the bottom end with an attachment flange 8, through which holes 10 pass, so that the post can be screwed to a stationary structure. The applicator head 2 can be fastened to the support post 6 in any desired position by means of a clamping device 12. For this purpose, a locking screw is tightened manually by means of a handle 14 so that a friction-locking connection is established between the locking device 12 and the support post 6, which connection can also be released again to allow adjustment.

On a section of the applicator head 2 (at the bottom in FIG. 1), there is a nozzle assembly, which is designed as a slot nozzle 16 and which is screwed to the base body 4, so that adhesive can flow through the adhesive channel into the slot nozzle 16 and then be discharged through a slot with an elongated, slot-like exit opening 18. During operation, the strip material to be glued slides along a slide plate 19 in the direction of the arrow 21 (FIG. 1), which illustrates the direction of relative motion.

In the applicator head 2, there is an applicator valve (not shown) for the selective blocking or release of the flow of adhesive through the adhesive channel and thus through the exit opening 18. The applicator valve can be actuated pneumatically. For example, a needle valve can be used, in which a needle cooperates with a valve seat.

A sealing body (not shown) is mounted with freedom of movement in the slot of the slot nozzle 16 and seals off the slot laterally. The sealing body is rigidly connected to a cylindrical piston, which moves axially inside one of the distribution channels. The sealing body extends from the piston to the exit opening 18 of the slot nozzle 16. By shifting the sealing body in the slot together with the piston in the distribution channel, the length of the slot and thus the length of the exit opening 18 can be varied.

By rotating a handwheel 20, which is connected to a threaded rod 24, the width of the slot and thus the width of the exit opening 18 can be varied in the manner described above. By positioning the entire applicator head 2 and thus the slot nozzle 16, it is possible to arrive at the exact position of the slot and of the exit opening 18 desired.

The guide device 3, illustrated separately in FIGS. 2, 5, and 6, is mounted directly on the applicator head 2, or, more precisely, on the base body 2 of the applicator head, by means of a swivel joint 26, so that the guide device 3 can be swiveled around a rotational axis 28 relative to the applicator head 2. The swivel joint 26 has a bolt 30, which is mounted in a hole in the base body 2, as well as a lock nut 31.

The guide device 3 serves to conduct the strip material past the exit opening 18 of the slot nozzle 16 in a defined manner. The strip material is first introduced through a slot 32, which is formed between two plates 34, 36 a certain distance apart, which are connected to each other by a connecting web 33. The strip material is conducted through the slot 32 by suitable conveying means (not shown) and thus guided. Alternatively, it would also be possible to provide only a single plate as a guide for the strip material in the feed area.

The guide device 3 has a first guide element 38, which is designed as a rigid cylindrical bolt with a polished surface and which is essentially parallel to the exit opening 18. During operation, the first guide element 38 is in its working position at a defined, adjustable distance from the exit opening of the slot nozzle (compare FIG. 3) and in contact with a surface of the strip material, which is opposite the surface of the strip material to be glued. The guide element 38 fits into a holding fixture 40 and can be removed or replaced by loosening the screw 42, so that it can easily be cleaned.

Two additional edge-guide elements 46, 48, attached to a support 44 (see FIG. 3) ensure during operation that the strip material is guided laterally, i.e., at the top and bottom in the example shown here, these additional edge-guide elements 46, 48 contacting opposite edges or borders of the strip material. The support 44 is designed in the form of a rod. By means of screws 50, the distance of the guide elements 46, 48 from each other can be adjusted; that is, after screws 50 have been loosened, the edge-guide elements 46, 48 can be slid along the support 44 until in the desired position, whereupon the screws 50 are tightened again. It is therefore possible to adapt the device to strip materials of different widths with a mechanism of very simple design. As a result of the guidance provided by the guide element 38 and additionally by the edge-guide elements 46, 48, the strip material to be glued is guided reliably so that the glue can be applied uniformly in two dimensions.

The support 44 can also be moved in the vertical direction to arrive at a so-called production zero point by the use of an adjusting screw 52.

The guide device can be swiveled by means of a pneumatic cylinder 58 around the rotational axis 28 of the swivel joint 26. A swivel support 54 holds the holding ficture 40 and thus the first guide element 38 as well as the additional edge-guide elements 46, 48 and their support 46 [sic; 44--Tr. Ed.]. The pneumatic cylinder 58 can be actuated with pressurized gas supplied through a compressed air line 60 in such a way that the support 54 is swiveled by a piston rod 62 away from the applicator head 2 and the base body 4 and thus into the desired working position, so that the guide element 38 is situated at the desired distance from the exit opening 18.

When the compressed air is turned off, the support 54 swings back into a rest position as a result of the force of the spring integrated into the pneumatic cylinder 58, in which rest position the guide element 38 is farther away from the exit opening 18 and the strip material is no longer being conducted past the exit opening to receive a coating of glue. The spring is thus a preloading device for exerting a preloading force on the swiveling guide device 3 and on the guide element 38 toward a rest position, in which the guide element 3 is held a certain distance away from the slot nozzle 16.

1. Device for the two-dimensional application of free-flowing adhesive to strip material, especially to furniture edge banding, which is in motion relative to the device,
with an adhesive channel in an applicator head (2),
with an applicator valve for the selective blocking or release of the flow of adhesive in the adhesive channel, and
with a slot nozzle (16) communicating with the adhesive channel, which nozzle has a slot and an elongated, slot-shaped exit opening (18) for dispensing the adhesive onto the strip material,
characterized in that a guide device (3) for conveying the strip material past the exit opening (18) of the slot nozzle (16) along a defined path can be attached removably to the applicator head (2), in that the guide device (3) has a first guide element (38), which comes in contact during operation with a surface of the strip material opposite the surface to be glued, and at least one additional guide element (46, 43), which comes in contact during operation with an edge of the strip material.

2. Device according to claim 1, characterized in that the guide device (3) is supported by means of a swivel joint (26) on the applicator head (2) with the freedom to swivel.

3. Device according to claim 2, characterized in that the guide device (3) is mounted with freedom to swivel under the action of a pneumatic cylinder (58), and in that the first guide element (38) is mounted a certain distance away from the swivel joint (26) such that, when the guide device (3) swivels, the distance between the first guide element (38) and the exit opening (18) of the slot nozzle (16) changes.

4. Device according to claim 2 or claim 3, characterized by a preloading device for exerting a preloading force on the guide device (3) and/or the guide element (38) toward a rest position, in which the guide element (38) is a certain distance away from the slot nozzle (16).

5. Device according to claim 4, characterized in that the preloading device is designed as a spring.

6. Device according to one of the preceding claims, characterized in that the first guide element (38) is designed as a cylindrical bolt and is essentially parallel to the exit opening (18).

7. Device according to one of the preceding claims, characterized in that two additional edge-guide elements (46, 48) can be fixed in position on a support (44) at a variable distance from each other.

8. Device according to claim 7, characterized in that the support (44) is supported on the guide device (3) along with the edge-guide elements (46, 48) so that it can be adjusted and held in position.

9. Device according to one of the preceding claims, characterized in that the guide device (3) has a guide slot (32) formed by two plates (34, 36) a certain distance apart, through which the strip material to be glued is conducted.

10. Device according to at least one of the preceding claims, characterized in that the length of the slot is variable, and in that the applicator head (2) is supported so that it can be positioned as desired and then fixed in that position.

11. Guide device for conducting strip material past an exit opening of a slot nozzle (16) along a defined path, especially for removable attachment to a device according to one of the preceding claims, where the guide device (3) has a first guide element (38), which comes in contact during operation with a surface of the strip material opposite the surface to be glued, and at least one additional guide element (46, 48), which comes in contact during operation with an edge of the strip material.
